(19) United States
(12) Patent Application Publication
(10) Pub. No.: US 2012/0016816 A1
(43) Pub. Date: Jan. 19, 2012

(54) DISTRIBUTED COMPUTING SYSTEM FOR PARALLEL MACHINE LEARNING

(75) Inventors: Toshihiko YANASE, Kodaira (JP); Kohsuke Yanai, Bangalore (IN); Keiichi Hiroki, Hachioji (JP)

(73) Assignee: Hitachi, Ltd.

(21) Appl. No.: 13/176,809

(22) Filed: Jul. 6, 2011

(30) Foreign Application Priority Data
Jul. 15, 2010 (JP) 2010-160551

(51) Int. Cl. G06F 15/18

(52) U.S. Cl. 706/10

(57) ABSTRACT

A controller of a distributed computing system assigns feature vectors, and assigns data processors and a model updater to first computers. The data processors have charge of iteration calculation of machine learning algorithms, acquire the feature vectors over a network when starting learning, and store the feature vectors in a local storage. In iteration of second and subsequent learning processes, the data processors load the feature vectors from the local storage, and conduct the learning process. The feature vectors are retained in the local storage till completion of learning. The data processors send only the learning results to the model updater, and waits for a next input from the model updater. The model updater conducts the initialization, integration, and convergence check of the model parameters, completes the processing if the model parameters are converged, and transmits new model parameters to the data processor if the model parameters are not converged.

### CLAIM OF PRIORITY

The present application claims priority from Japanese patent application JP 2010-160551 filed on Jul. 15, 2010, the content of which is hereby incorporated by reference into this application.

### FIELD OF THE INVENTION

The present invention relates to a distributed computing system, and more particularly to a parallel control program of machine learning algorithms, and a distributed computing system that operates by the control program.

### BACKGROUND OF THE INVENTION

In recent years, with the progression of computer commoditization, it becomes easier to acquire data and to store it. For that reason, needs that a large amount of business data is analyzed and applied to an improvement in business is growing.

In processing a large amount of data, a technique is applied in which multiple computers are used to increase a processing speed. However, implementation of conventional distributed processing is complicated, and high in the implementation costs, which are problematic.

In recent years, attention is paid to a software platform and a computer system which facilitate the implementation of the distributed processing.

As one implementation, MapReduce disclosed in U.S. Pat. No. 7,650,331 has been known. In the MapReduce, a Map process that allows respective computers to execute computation in parallel, and a Reduce process that aggregates the results of the Map process are combined together to execute the distributed processing. The Map process reads data from a distributed file system in parallel to efficiently realize parallel input and output. A programmer of a program only has to create a distributed processing Map and an aggregation processing Reduce. The software platform of the MapReduce executes assignment of the Map process to the computers, scheduling such as waiting for end of the Map process, and the details of data communication. For the above reasons, the MapReduce of U.S. Pat. No. 7,650,331 can suppress the costs required for implementation as compared with the distributed processing of Japanese Unexamined Patent Application Publication No. 2004-326480, Japanese Unexamined Patent Application Publication No. 2004-326480, and Japanese Unexamined Patent Application Publication No. Hei11(1999)-175483.

As a technique in which data is analyzed by the computer, and knowledge is extracted, attention is paid to machine learning. The machine learning can improve precision of knowledge obtained by using a large amount of data through input, and is variously devised. For example, U.S. Pat. No. 7,222,127 proposes machine learning for a large amount of data. Also, Japanese Unexamined Patent Application Publication (translation of PCT application) No. 2009-505290 proposes one technique of the machine learning using the MapReduce. The techniques of U.S. Pat. No. 7,222,127 and Japanese Unexamined Patent Application Publication (translation of PCT application) No. 2009-505290 enable distribution of the learning process, but suffer from such a problem that inefficient data access that the same data is communicated many times is conducted. Many of the machine learning include iterative algorithms, and the same data is iteratively accessed. When the MapReduce is applied to the machine learning, because data reuse is not conducted in an iterative process, a data access rate is decreased.

Japanese Unexamined Patent Application Publication No. 2010-092222 realizes a cache mechanism that can effectively use a cache in the MapReduce process on the basis of an update frequency. This technique introduces the cache in the Reduce process. However, because a large amount of data is iteratively used for the Map process in the machine learning, an improvement in the rate contributed by the cache in the Reduce process is smaller than that of a Map processor.

In Jaliya Ekanayake, et al “MapReduce for data Intensive Scientific Analyses”, [online], [searched on Jun. 30, 2010], Internet URL:http://grids.ucs.indiana.edu/ptliupages/publications/ekanayake-MapReduce.pdf, the MapReduce is modified to be suitable for iterative execution, and Map and Reduce processes are held over the overall execution, and the processes are reused. However, the efficient reuse of data over the overall iteration is not conducted.

### SUMMARY OF THE INVENTION

When the distributed computing system is used for the parallel machine learning, a large amount of data can be learned in a shorter time. However, when the MapReduce is used for the parallel machine learning, there arises a problem confronting a reduction in the execution rate and a difficulty related to the memory use.

As illustrated in FIG. 11, architecture is made for only one process of the MapReduce. A process having charge of the Map process is ended once the process is completed, and releases feature vectors. Because the machine learning requires the iterative process, start and end of the Map process, and data load from a file system (storage) to a main memory are iterated in an iterative process part, resulting in a reduction in the execution rate.

In the MapReduce, since the details of data load are invisible due to the software platform, the assignment of data to the respective computers is entrusted to the system. Therefore, the degree of freedom of the file system and the memory, which can be managed by a user, is small. For that reason, processing of data exceeding a total amount of a main memory in each computer occurs, there arises such a problem that an access to the file system increases to extremely decrease the processing speed, or to stop the processing. The above-mentioned known techniques cannot realize solution to those problems.

Under the above circumstances, the present invention has been made in view of the above circumstances, and aims at a distributed computing system for parallel machine learning, which suppresses start and end of a learning process and data load from a file system to improve a processing speed of machine learning.

According to one aspect of the present invention, a distributed computing system includes: a first computer including a processor, a main memory, and a local storage; a second computer including a processor and a main memory, and instructing a distributed process to the first computers; a storage that stores data used for the distributed process; and a network that connects the first computers, the second computer, and the storage, for conducting the parallel process by the first computers, and the second computer includes a controller that allows the first computers to execute a learning process as the distributed process, and the controller causes a given number of first computers among the first computers to execute the learning process as first worker nodes by assigning data processors that execute the learning process and the data in the storage to be learned for each of the data processors to the given number of first computers, and the controller causes at least one first computer among the first computers to execute the learning process as a second worker node by assigning a model updater that receives outputs of the data processors and updates a learning model to the one first computer, and in the first worker nodes, each data processor loads the data assigned from the second computer from the storage, and stores the data into the local storage, sequentially loads the unprocessed data among the data in the local storage in an area secured in advance on the main memory, executes the learning process on the data in the data in the data area, and sends a results of the learning process to the second worker node, and in the second worker node, the model updater receives the results of the learning processes from the first worker nodes, updates the learning model from the results of the learning processes, determining whether the updated learning model satisfies a given reference, or not, sends the updated learning model to the first worker nodes to instruct the first worker nodes to conduct the learning process if the updated learning model does not satisfy the given reference, and sends the updated learning model to the second worker node to instruct the first worker nodes to conduct the learning process if the updated learning model satisfies the given reference.

Accordingly, in the distributed computing system according to the aspects of the present invention, data to be learned is retained in the local storage that is accessed by the data processor and the data area on the main memory during conducting the learning process whereby the number of start and end of the data processor and the communication costs of the data with the storage can be reduced to (1/the number of iteration). The machine learning can therefore be efficiently executed in parallel. Further, the data processor accesses to the storage, the memory, and the local storage whereby the learning data exceeding the total amount of memories in the overall distributed computing system can be efficiently dealt with.

### BRIEF DESCRIPTION OF THE DRAWINGS

FIG. 1 is a block diagram of a computer used for a distributed computer system according to a first embodiment of the present invention;

FIG. 2 is a block diagram of the distributed computer system according to the first embodiment of the present invention;

FIG. 3 is a block diagram illustrating functional elements of the distributed computer system according to the first embodiment of the present invention;

FIG. 4 is a flowchart illustrating an example of an entire process executed by the distributed computer system according to the first embodiment of the present invention;

FIG. 5 is a sequence diagram illustrating a data flow in the distributed computer system according to the first embodiment of the present invention;

FIG. 6 is a flowchart for realizing a k-means clustering method in the distributed computer system according to the first embodiment of the present invention;

FIG. 7A is a schematic diagram illustrating a portion provided to a user by the distributed computer system and a portion created by the user in a program of a data processor used in the present invention according to the first embodiment of the present invention;

FIG. 7B is a schematic diagram illustrating a portion provided to a user by the distributed computer system and a portion created by the user in a program of a model updater used in the present invention according to the first embodiment of the present invention;

FIG. 8A is an illustrative diagram illustrating feature vectors of clustering, which is an example of feature vectors used in machine learning according to the first embodiment of the present invention;

FIG. 8B is an illustrative diagram illustrating feature vectors of a classification problem, which is an example of feature vectors used in machine learning according to the first embodiment of the present invention;

FIG. 9 is a schematic diagram illustrating an example in which the data processor loads the feature vectors of a local file system into a main memory according to the first embodiment of the present invention;

FIG. 10 is a sequence diagram illustrating an example in which the data processor loads the feature vectors of the local file system into the main memory according to the first embodiment of the present invention;

FIG. 11 is a block diagram illustrating a configuration example of a distributed computing system based on a MapReduce in a conventional art;

FIG. 12 is a flowchart illustrating an example of a process in the MapReduce in the conventional art;

FIG. 13 is a sequence diagram illustrating an example of a communication procedure for realizing machine learning on the basis of the MapReduce in the conventional art;

FIG. 14 is a diagram illustrating a relationship between the number of records of the feature vectors and an execution time when k-means is executed on the basis of the first embodiment and the MapReduce in the conventional art; and

FIG. 15 is a diagram illustrating a relationship between the number of data processors and a speed-up when the k-means is executed on the basis of the first embodiment of the present invention.

### DETAILED DESCRIPTION OF THE PREFERRED EMBODIMENTS

Hereinafter, embodiments of the present invention will be described with reference to the accompanying drawings.

In the following embodiments, when the number of components is referred to, the present invention is not limited to a specific number and may be larger or smaller than the specific value except for a case in which the number is particularly specified or specified clearly in principle.

Further, in the following embodiments, it is apparent that the components in the embodiments are not always essential except for a case in which the components are particularly specified or required clearly in principle. Also, in the following embodiments, when the shapes and positional relationships of the components are referred to, the present invention includes substantially approximation or similarity of the shapes except for a case in which it is clearly specified or it is clearly conceivable in principle that this is not the case. This is applied to the above numerical values and ranges.

### First Embodiment

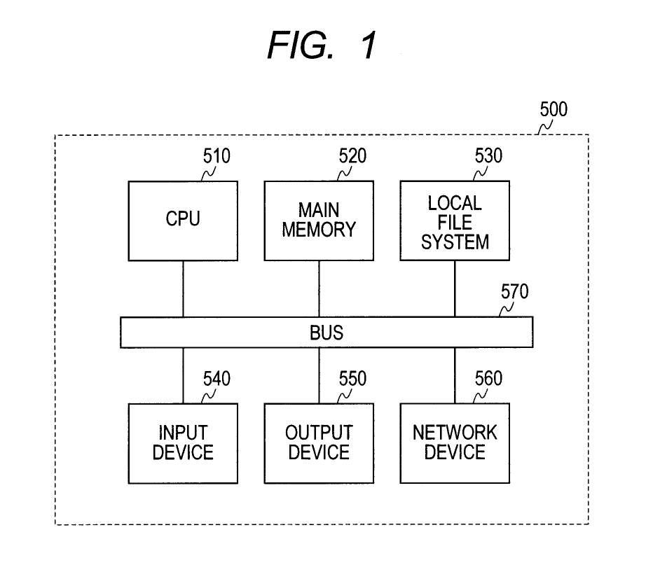

FIG. 1 is a block diagram of a computer used for a distributed computer system according to the present invention. A computer 500 used in the distributed computer system assumes a general-purpose computer 500 illustrated in FIG. 1, and specifically comprises of a PC server. The PC server includes a central processing unit (CPU) 510, a main memory 520, a local file system 530, an input device 540, an output device 550, a network device 560, and a bus 570. The respective devices from the CPU 510 to the network device 560 are connected by the bus 570. When the computer 500 is operated from a remote over a network, the input device 540 and the output device 550 can be omitted. Also, each of the local file systems 530 is directed to a rewritable storage area incorporated into the computer 500 or connected externally, and specifically, a storage such as a hard disk drive (HDD), a solid state drive (SSD), or a RAM disk.

Hereinafter, machine learning algorithms to which the present invention is adapted will be described in brief. The machine learning is intended to extract a common pattern appearing in feature vectors. Examples of the machine learning algorithms are k-means (J. McQueen “Some methods for classification and analysis of multivariate observations” In Proceedings of the Fifth Berkeley Symposium on Mathematical Statistics and Probability, pp. 281-297, 1967), and SVM (Support Vector Machine; Chapelle, Olivier: Training a Support Vector Machine in the Primal, Neural Computation, Vol. 19, No. 5, pp. 1155-1178, 2007). As data treated in the machine learning algorithms, there are the feature vectors from which a pattern is extracted and model parameters to be learned. In the machine learning, a model is determined in advance, and model parameters are determined so as to apply well to the feature vectors. For example, in a linear model of the feature vectors {(x1, y1), (x2, y2), . . . }, the model is represented by a function f as follows.

f(x)=(w,x)+b

where (w, x) represents an inner product of vectors w and x. The symbols w and b in the above expression are the model parameters. The purpose of the machine learning is to determine w and b so as to satisfy yi=f(xi) with a small error. In the following description, estimate of the model parameters with the use of the feature vectors is called “learning”.

The machine learning algorithms such as the above k-means and SVM conducts learning by iterating the execution of data processing and the execution of model update. The data processing and the model update are repeated until the convergence criteria of the model parameters set for each of the algorithms is satisfied. The data processing means that the model is applied to the feature vectors with the use of the model parameters that are a present estimate value. For example, in a case of the above linear model, the function f having w and b that are the present estimate values is applied to the feature vectors to calculate an error. In the model update, the model parameters are again estimated with the use of the results of the data processing. The data processing and the model update are repeated to enhance an estimate precision of the model parameters.

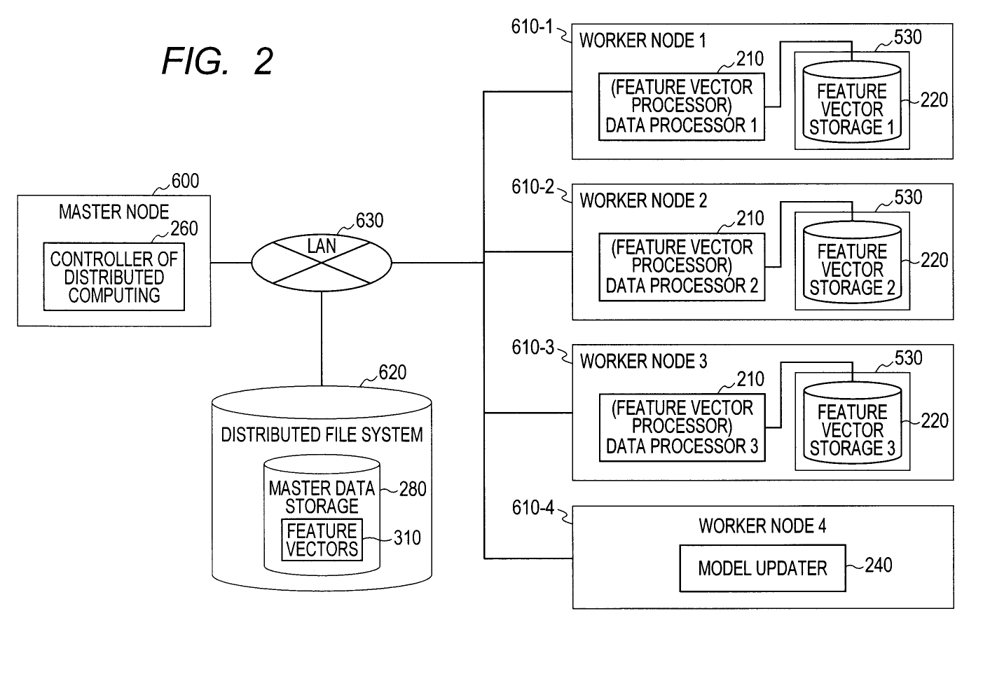

FIG. 2 is a block diagram of the distributed computer system according to the present invention. In the computer used in the present invention, as illustrated in FIG. 2, one master node 600 and one or more worker nodes 610-1 to 610-4 are connected to each other over a network (LAN) 630.

Each of the master node 600 and the worker nodes 610 comprises of the computer 500 illustrated in FIG. 1. The master node 600 executes a controller of distributed computing 26 that will be described later. The worker nodes 610-1 to 610-4 execute data processors 210 or a model updater 240 which will be described later. In FIG. 2, four of the worker nodes 1 to 4 (610-1 to 610-4) are exemplified, and a generic name of those worker nodes is the worker nodes 610. The worker nodes 1 to 3 (610-1 to 610-3) the data processors 1 to 3, respectively, and since those data processors 210 are the same program, a generic name thereof is the data processors 210. The respective worker nodes 1 to 3 store feature vectors 310 assigned to feature vector storages 1 to 3 (220) of the local file systems 530, respectively, and the respective data processors 210 refer to the feature vectors 310. A generic name of the feature vector storages 1 to 3 is the feature vector storages 220.

Each of the data processor 210 is a program that retains the feature vectors, applies the feature vectors to the model parameters assigned from the model updater 240, and outputs partial outputs.

The model updater 240 is a program that aggregates the partial outputs assigned from the data processors 210, again estimates the model parameters, and updates the model parameters. The model updater 240 also determines whether the model parameters are converged, or not.

The worker node 4 (610-4) executes the model updater 240. Also, the data processors 210 and the model updater 240 can be provided together in one computer.

The master node 600 and the worker nodes 610 are connected by a general computer network device, and specifically connected by a LAN (hereinafter referred to as network) 630. Also, the LAN 630 is connected with a distributed file system 620. The distributed file system 620 functions as a storage having a master data storage 280 that stores the feature vectors 310 that is a target of machine learning, and comprises of multiple computers, and specifically uses an HDFS (hadoop distributed file system). The distributed file system 620, the master node 600, and the worker nodes 610 are connected by the network 630. The master node 600 and the worker nodes 610 can also function as elements configuring the distributed file system 620.

The master node 600 retains a list of IP addresses or host names of the worker nodes, and manages the worker nodes 610. A computational resource available by the worker nodes 610 is grasped by the master node 600. The available computational resource is directed to the number of threads executable at the same time, a maximum value of usable memory amount, and a maximum value of an available capacity in the local file systems 530.

When the worker nodes 610 are added, in order to access to the distributed file system 620 as setting at the worker nodes 610 side, there is a need to install an agent of the distributed file system 620. Also, as setting at the master node 600 side, the IP addresses and the host names of the distributed file system 620 as well as information on the computational resource is added.

Because the network 630 that connects the master node 600, the worker nodes 610, and the distributed file system 620 needs a communication speed, the network 630 exists within one data center. The master node 600, the worker nodes 610, or each component of the distributed file system 620 can be placed in another data center. However, because there arise problems on a bandwidth and a delay of the network, a data transfer rate is decreased in such a case.

The master node 600 executes a controller of distributed computing 260 that manages the worker nodes 610. The master node 600 receives assignment of the feature vectors 310 for machine learning from the input device 540 illustrated in FIG. 1, and setting related to distributed processing in the machine learning, of a model (learning model) of the machine learning, a parameter, and a parameter of dispersion execution. The controller of distributed computing 260 of the master node 600 sets the worker nodes 610 used for distributed computing, the feature vectors 310 assigned to each worker node 610, the learning model of the machine learning, and the parameter for the data processors 210 and the model updater 240 on the basis of the accepted setting, sends the setting results to each worker node 610, and executes the distributed computing of the machine learning as will be described later.

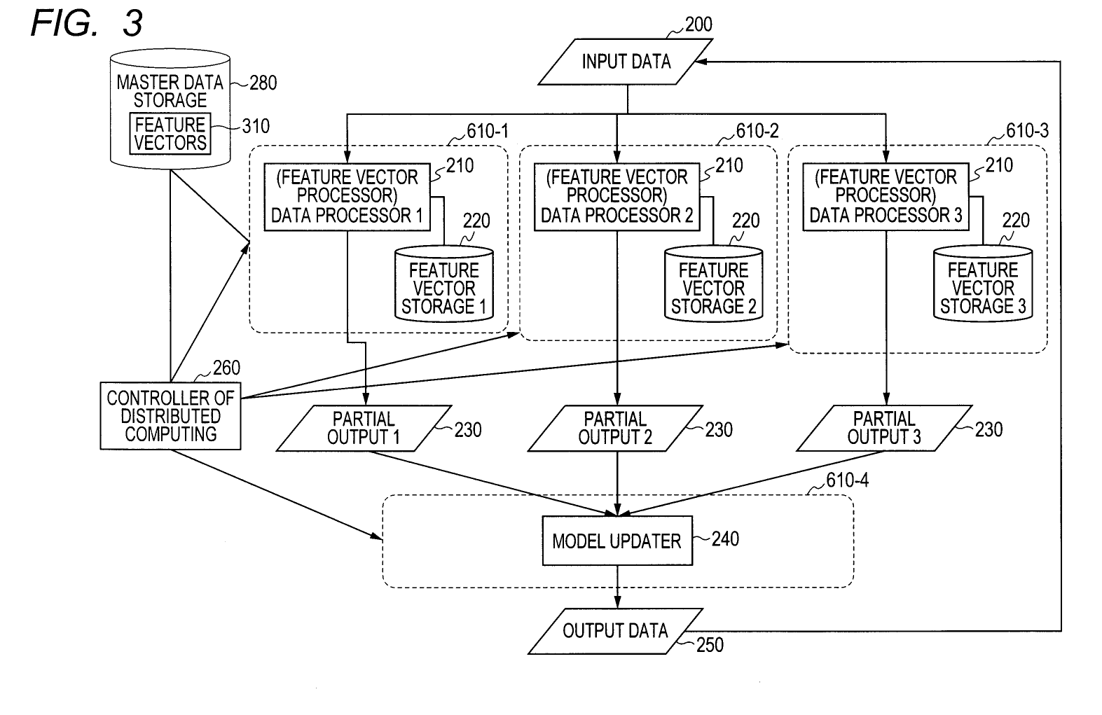

FIG. 3 is a block diagram illustrating functional elements of the distributed computer system according to the present invention.

As illustrated in FIG. 3, the machine learning is implemented as software executable by a CPU. Software of the machine learning is provided for, the master node 600 and the worker nodes 610. The software operative by the master node 600 is the controller of distributed computing 260, and assigns the feature vectors to each worker node 610, and assigns software executed by the worker nodes 610. There are two kinds of software executed by the worker nodes 610.

First software for the worker nodes 610 is each data processor 210 that acquires the feature vectors 310 from the master data storage 280 of the distributed file system 620, communicates data with the controller of distributed computing 260, and conducts a learning process using the feature vector storages 220. The data processors 210 receives the input data 200 from the worker node 4, and conducts processing with the use of the feature vectors read from the main memory 520 to output partial output data 230.

The other software is the model updater 240 that initializes the machine learning, integrates the results, and checks convergence. The model updater 240 is executed by the worker node 4 (610-4), receives the partial output data 230 (partial output 1 to partial output 3 in the figure) from the data processors 210, conducts given processing, and returns output data 250 that is an output of the system. In this situation, when the convergence conditions are not satisfied, the system again conducts the learning process with the output data 250 as input data.

Subsequently, a procedure of starting the distributed computer system will be described. A user of the distributed file system turns on a power of the master node 600, and starts an OS (operating system). Likewise, the user turns on powers of all the worker nodes 610, and starts an OS. All of the master node 600 and the worker nodes 610 are allowed to be accessed to the distributed file system 620.

All of the IP addresses and the host names of the worker nodes 610 used for the machine learning are added to a setting film (not shown) stored in the master node 600 in advance. In the subsequent process, the respective processes of the controller of distributed computing 260, the data processors 210, and the model updater 240 conduct communications on the basis of the IP addresses and the host names.

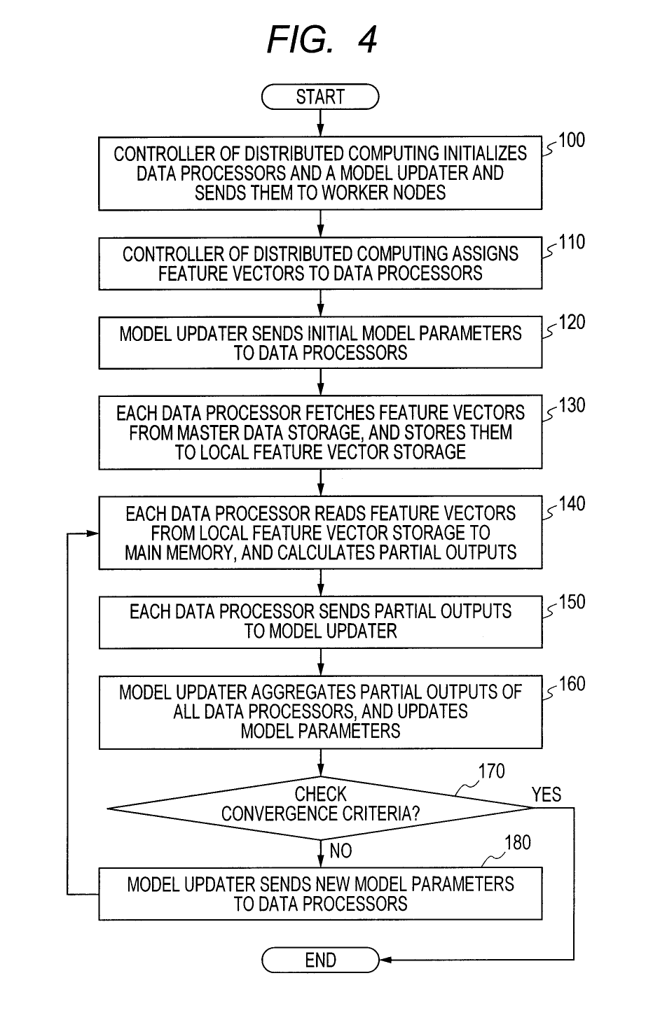

FIG. 4 is a flowchart illustrating an example of an entire process executed by the distributed computer system.

First, in Step 100, the controller of distributed computing 260 in the master node 600 initializes the data processors 210 and the model updater 240, sends the data processors 210 to the worker nodes 1 to 3, and sends the model updater 240 to the worker node 4. The controller of distributed computing 260 sends the data processors 210 and the model updater 240 together with the learning model and the learning parameter.

In Step 110, the controller of distributed computing 260 in the master node 600 divides the feature vectors 310 in the master data storage 280 held by the distributed file system 620, and assigns the feature vectors 310 to the respective data processors 210. The division of the feature vectors 310 is conducted so that no duplication occurs.

In Step 120, the model updater 240 of the worker node 4 initializes the learning parameter, and sends an initial parameter of the learning parameter to the data processors 210 of the worker nodes 1 to 3.

In Step 130, each of the data processors 210 of the worker nodes 1 to 3 fetches assigned portions of the feature vectors 310 from the master data storage 280 in the distributed file system 620, and stores the assigned portions in the feature vector storages 220 of the local file systems 530 as the feature vectors 1 to 3, respectively. The data communication between the distributed file system 620 and the worker nodes 1 to 3 is conducted only in this step 130, and in the subsequent procedures, the feature vectors from the distributed file system 620 are not read.

In Step 140, each of the data processors 210 in the worker nodes 1 to 3 sequentially reads the feature vectors 1 to 3 from the local file systems 530 to the main memory 520 by each given amount, and applies the feature vectors to the model parameters delivered from the model updater 240, and output intermediate results as partial outputs. Each of the data processors 210 reads the feature vectors ensures a given data area for reading the feature vectors from each local file system 530 on the main memory 520, and conducts the processing on the feature vectors loaded in the data area. Then, the data processors 210 reads the unprocessed feature vectors in the local file systems 530 in the data area every time Step 140 is iterated, and iterates the processing.

In Step 150, each of the data processors 210 in the worker nodes 1 to 3 sends the partial outputs which are the intermediate results to the model updater 240.

In Step 160, the model updater 240 aggregates the parameters received from the respective worker nodes 1 to 3, and again estimates and updates the model parameters. For example, if an error when applying the feature vectors to the model from the respective data processors 210, is sent as the partial outputs, the model parameters are updated to a value expected to become smallest in the error, taking all of the error values into consideration.

In Step 170, the model updater 240 in the worker node 610 checks whether the model parameters updated in Step 160 are converged, or not. Convergence criteria are set for each of the algorithms of the machine learning. If it is determined that the learning parameter is not yet been converged, the processing is advanced to Step 180, and the master node 600 sends new model parameters to the respective worker nodes. Then, the processing turns to Step 140, and the processing of the data processor and the processing of the model updater are iterated until the model parameters are converged. On the other hand, if it is determined that the model parameters are converged, the processing comes away from the loop, and is completed.

When the model updater 240 in the worker node 4 determines that the model parameters are converged, the model updater 240 sends the model parameters to the master node 600. Upon receiving the model parameters that are the results of the learning process from the worker node 4, the master node 600 detects completion of the learning process. The master node 600 instructs the worker nodes 1 to 4 to complete the learning process (data processors 210 and model updater 240).

Upon receiving an instruction to complete the learning process from the master node 600, the worker nodes 1 to 4 release the feature vectors on the main memory 520 and the file (the feature vectors) on the local file systems 530. After releasing the feature vectors, the worker nodes 1 to 3 complete the learning process.

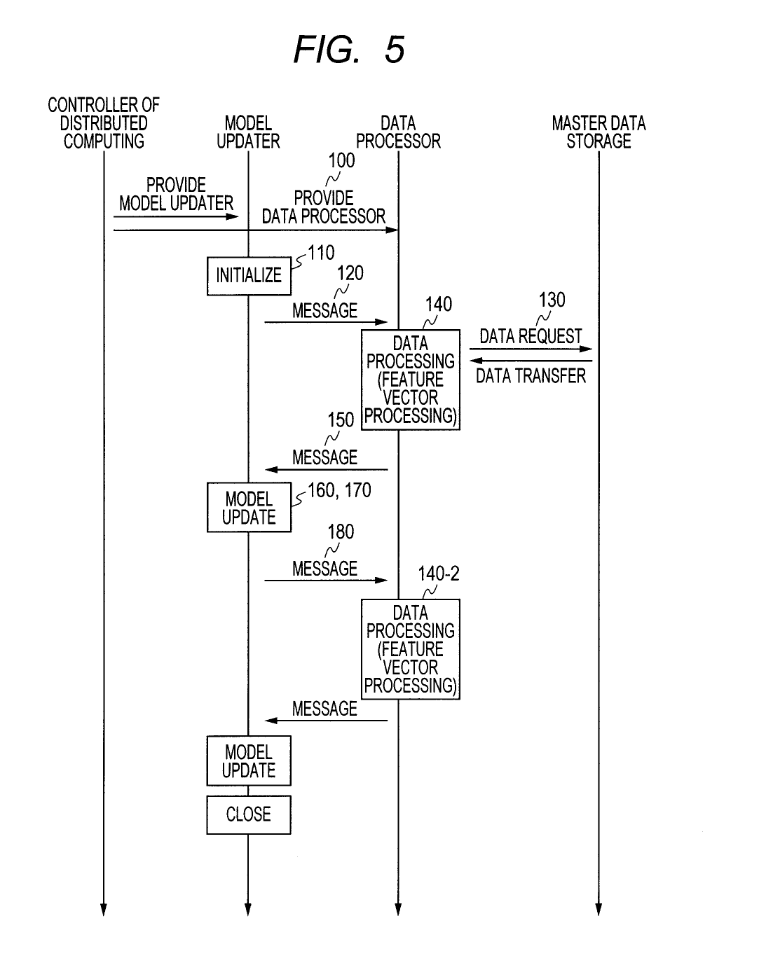

A case in which the above processing is iterated twice is illustrated in FIG. 5. FIG. 5 is a sequence diagram illustrating a data flow in the distributed computer system.

In a process of a first data processor 140, the data processors 210 in the worker nodes 1 to 3 access to the master data storage 280 in the distributed file system 620 to acquire the feature vectors 1 to 3. However, in a second data processor 140-2, it is found that no data communication is conducted with the distributed file system 620. As a result, the present invention reduces a load of the network 630.

This flowchart enables a large number of the machine learning algorithms to be parallelized even in any number of parallels. The machine learning is the machine learning algorithms having the following three features.
1) The machine learning has classification models and regression models.
2) The machine learning checks the validity of model parameters by applying the feature vectors to the above models.
3) The machine learning feeds back the validity of the model parameters, and again estimates and updates the model parameters.

Among those features, a portion in which the feature vectors are scanned in a procedure of the feature 2) among the above features is distributed into multiple worker nodes as the data processors 210, and integrated processing is conducted by the model updater 240 to parallelize the machine learning algorithms in the present invention.

For that reason, the present invention can be applied to the learning algorithms that can read the learning data in parallel in the procedure of the above feature 2). As such algorithms, there are known k-means and SVM (support vector machine), and the present invention can be applied to typical machine learning techniques.

For example, in the case of the k-means algorithms, as the model (classification model or regression model) parameters in the above feature 1), the machine learning has a centroid vector of each cluster. In the calculation of the validity of the model parameters, it is determined on the basis of the present model parameters, which cluster the feature vectors belong to. In the update of the model parameters in the feature 3), the centroid of the belonging feature vectors is calculated for each cluster classified in the feature 2) to update the centroid vector of each cluster. Also, if a difference of the centroid vector of each cluster before and after updating falls outside a given range, it is determined that the model parameters are not converged, and the procedure in the above feature 2) is executed with the use of the centroid vector newly calculated. In this example, the determination of which cluster the learning data in the feature 2) belongs to can be parallelized.

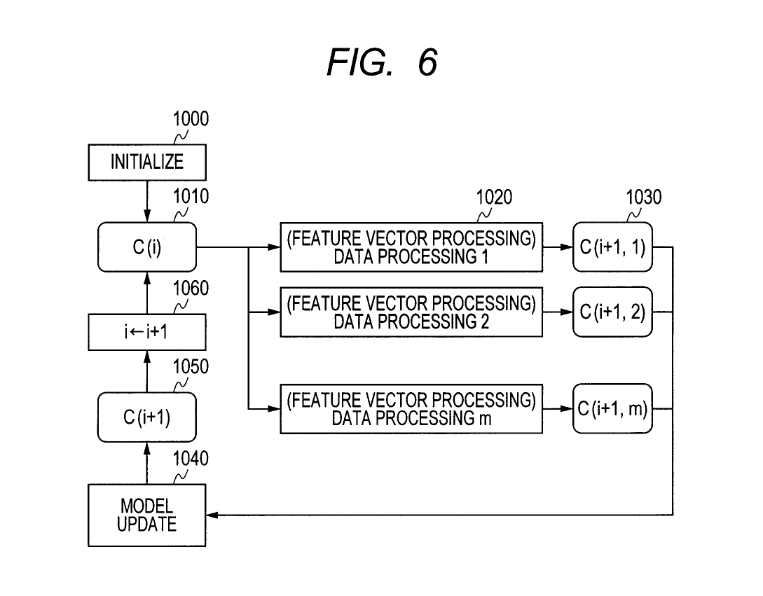

Hereinafter, a description will be given of a procedure of executing clustering of numerical vectors through the k-means clustering method on the distributed computer system of the present invention as a specific example with reference to FIG. 6. FIG. 6 is a flowchart for realizing a k-means clustering method in the distributed computer system according to the present invention.

Referring to FIG. 6, it is assumed that the controller of distributed computing 260 is executed in one master node 600 illustrated in FIG. 2, the model updater 240 is executed even by one worker node m+1, and the data processors 210 are executed by m worker nodes 610.

In Step 1000, initialization is executed. Step 1000 corresponds to Step 100 to Step 130 in FIG. 4. Firstly, in the master node 600, the controller of distributed computing 260 initializes the respective data processors 210 and the model updater 240, and sends the data processors 210 and the model updater 240 to the respective worker nodes 610. Then, the controller of distributed computing 260 assigns the feature vectors to the respective data processors 210. Then, the model updater 240 initializes k centroid vectors C(i) at random. The model updater 240 sends the centroid vector C(i) to the respective data processors 210. It is assumed that i represents the number of iteration, and an initial value is i=0. The respective data processors 210 load the feature vectors 310 from the master data storage 280 in the distributed file system 620, and stores the feature vectors 310 in the feature vector storages 220 of the local file systems 530.

The subsequent process from Step 1010 to Step 1060 corresponds to an iteration portion illustrated in Step 140 to step 180 in FIG. 4.

Step 1010 represents the present centroid C(i).

In Step 1020, the respective data processors 210 compares the numerical vectors contained in the assigned feature vectors 1 to 3 with the centroid vector C(i), and gives a label l, {l |1<=l<=k, lεZ} of the centroid vector smallest in the distance. In this expression, Z is a set of integers.

Further, the data processors 210 of j^{th} {j|1<=j<=m, j, mεZ} calculates the centroid vectors c(i, j) for each label with respect to the labeled numerical vectors. In Step 1030, the data processors 210 represent the centroid c(i, j) acquired in the process of the above Step 1020.

In Step 1040, the respective data processors 210 sends the calculated centroid vectors c(i, j) to the model updater 240. The model updater 240 receives centroid vectors from the respective data processors 210, and in Step 1050, the model updater 240 calculates the centroid vector of the entire labels from the centroid vectors for each label as a new centroid vector c(i+1). Then, the model updater 240 compares the above test data with the new centroid vector c(i+1) in distance, and gives a label of the closest centroid vector to check the convergence. If predetermined convergence criteria are satisfied, the processing is completed.

On the other hand, if the predetermined convergence criteria are not satisfied, 1 is added to the number of iteration i in Step 1060, and the model updater 240 again sends the centroid vector to the respective data processors 210. Then, the above processing is iterated.

In the above steps 1000 to 1060, the clustering of the numerical vectors can be executed by multiple worker nodes through the k-means clustering method.

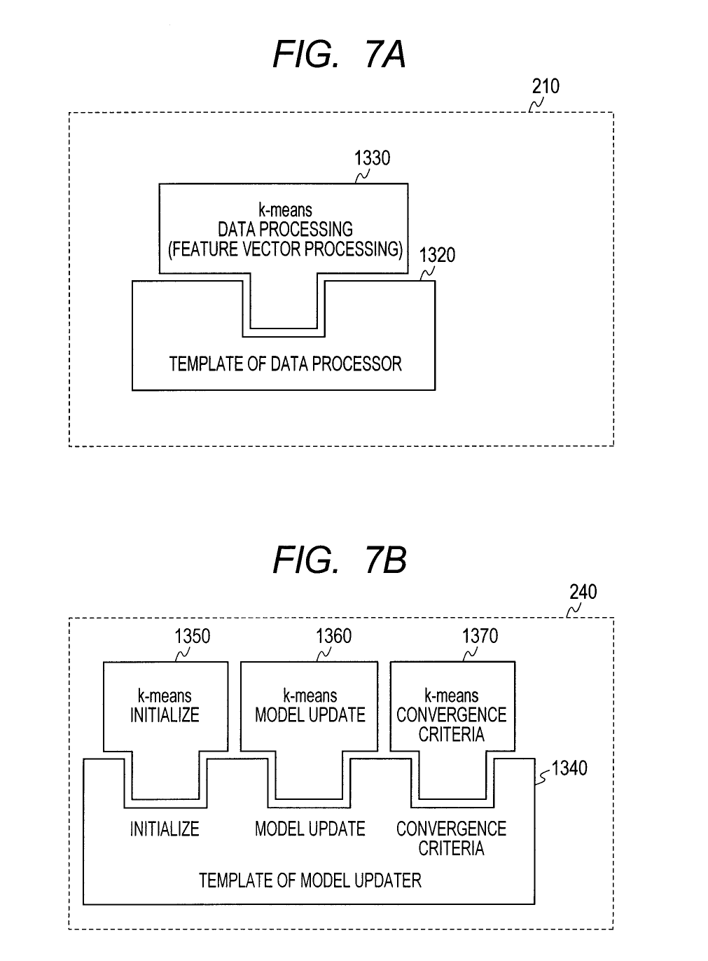

FIG. 7A is a schematic diagram illustrating a portion provided to a user by the distributed computer system and a portion created by the user in a program of a data processor 210 used in the present invention. FIG. 7B is a schematic diagram illustrating a portion provided to a user by the distributed computer system and a portion created by the user in a program of a model updater used in the present invention.

As illustrated in FIGS. 7A and 7B, each of the data processors 210 and the model updater 240 is divided into a common portion and a portion depending on the learning methods. In FIG. 7A, the common portion of the data processors 210 includes processing methods such as communication with the controller of distributed computing 260, the model updater 240, and the master data storage 280 in the distributed file system 620, and storage and read of data with respect to the feature vector storages 220. The common portion of the data processors 210 is implemented in a template of data processor 1320 in the data processors 210 in advance. For that reason, the user only has to create a k-means processing 1330 among the data processors 210.

In FIG. 7B, the model updater 240 has a common portion such as communication with the controller of distributed computing 260, the data processors 210, and the master data storage 280 in the distributed file system 620 implemented in a template of model update 1340. The user of the distributed computer system only has to create a k-means initialization 1350, a k-means model update 1360, and k-means convergence criteria 1370.

As described above, according to the present invention, because the portion common to the machine learning is prepared as the template, the amount of programs created by the user can be reduced, and the development can be efficiently conducted.

According to the present invention, the data processors 210, the model updater 240, and the controller of distributed computing 260 are structured as described in the above embodiment, thereby obtaining the following two functions and advantages.

(1) Reduction of communication of learning data over the network
(2) Reduction of the number of process starts and ends

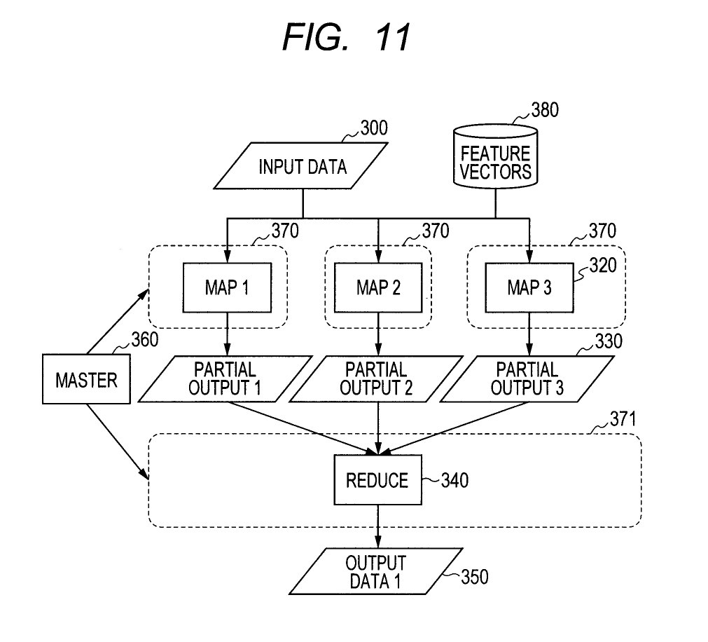

An example in which the MapReduce described in the conventional art is used for the machine learning is illustrated in FIGS. 11, 12, and 13. FIG. 11 is a block diagram illustrating a configuration example of a distributed computing system based on the MapReduce.

Referring to FIG. 11, a distributed computer system in the conventional art includes multiple computers 370 that executes multiple Mappers (Map1 to Map3) 320, one computer 371 that executes a Reducer 340, a master 360 that executes a master process for controlling the Mappers 320 and the Reducer 340, and a distributed file system 380 that retains the feature vectors.

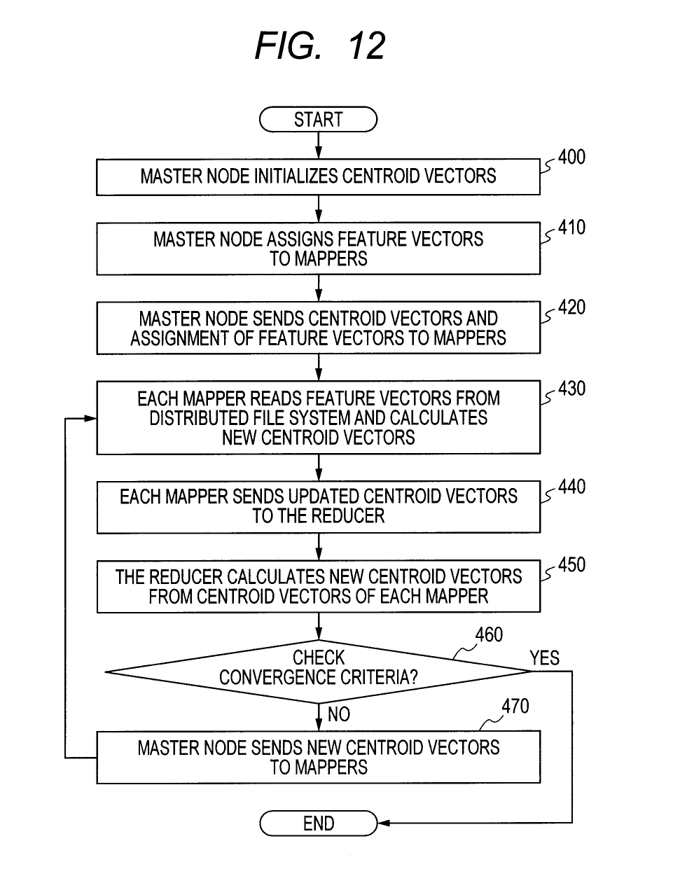

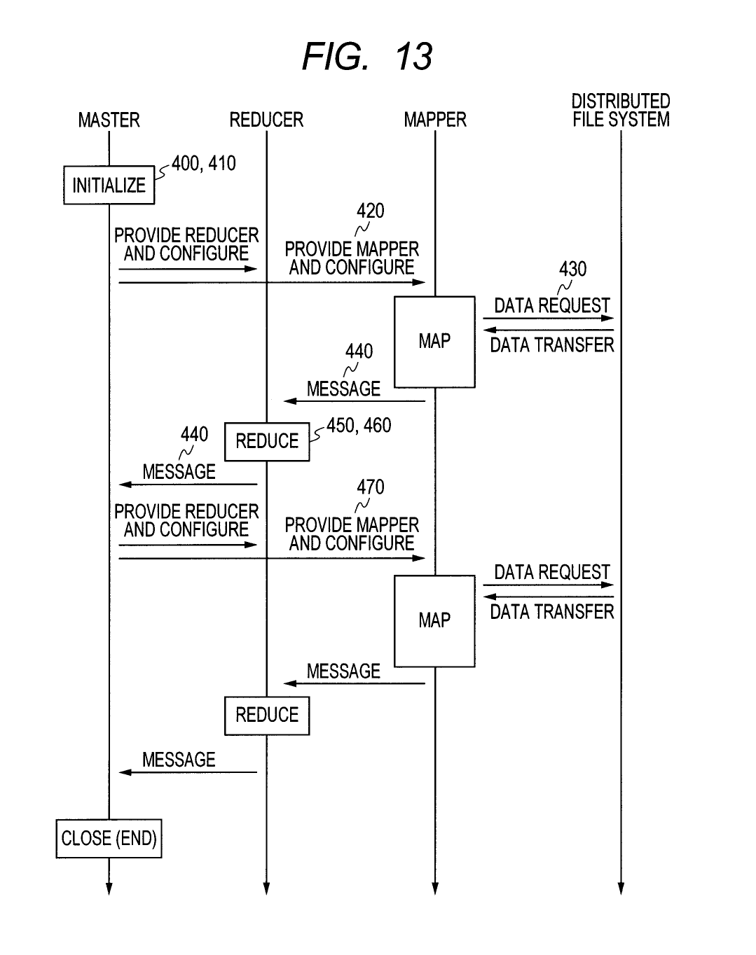

FIG. 12 is a flowchart illustrating an example of a process for conducting the machine learning by the MapReduce. FIG. 13 is a sequence diagram illustrating an example of a communication procedure for realizing the machine learning on the basis of the MapReduce of FIG. 12.

When it is assumed that the machine learning is conducted by an iteration process of n times with the use of the MapReduce described in the conventional art, a procedure of reading the feature vectors from the distributed file system 380 is iterated by n times as illustrated in FIGS. 12 and 13.

That is, referring to FIGS. 12 and 13, in Step 400, the master 360 initializes the centroid vectors. In Step 410, the master 360 assigns the feature vectors to the Mappers 320. In Step 420, the master 360 starts the respective Mappers 320, and sends the centroid vectors and the assigned feature vectors data.

In Step 430, the respective Mappers 320 read the feature vectors from the master data in the distributed file system 380, and calculate the centroid vectors. Then, in Step 440, the Mappers 320 send the acquired centroid vectors to the Reducer 340.

In Step 450, the Reducer 340 calculates the entire centroid vectors according to the multiple centroid vectors received from the respective Mappers 320, and updates the calculated centroid vectors as new centroid vectors.

In Step 460, the Reducer 340 compares the new centroid vector with a given reference, and determines whether the model parameters are converged, or not. If the reference is satisfied, and the model parameters are converged, the processing is completed. On the other hand, if the model parameters are not converged, the Reducer 340 notifies the master 360 that the model parameters are not yet converged in Step 470. Upon receiving such a notice, the master 360 starts the respective Mappers 320, and assigns the centroid vectors and the feature vectors to the respective Mappers. Thereafter, the master 360 returns to Step 430, and iterates the above processing. In FIG. 13, the same steps are denoted by identical reference symbols.

On the other hand, according to the present invention, as illustrated in Step 130 of FIG. 4, the number of reading the feature vectors from the master data storage 280 in the distributed file system 620 is only one execution of the data processors 210. For that reason, the communication traffic of the feature vectors over the network 630 is 1/n of the MapReduce in the conventional art.

Likewise, the start and end of the process is conducted by n times in the iteration process of n times in the MapReduce of the conventional art. On the other hand, according to the present invention, because the data processors 210 and the model updater 240 are not terminated during the processing, the number of start and end of the process becomes 1/n as compared with the conventional art.

As described above, on execution the machine learning in the distributed computer, the present invention can reduce the communication traffic of the network 630 and the CPU resource. That is, because the processes of the data processors 210 and the model updater 240 are retained, and the feature vectors on the memory can be reused, the number of start and end of the process can be reduced, and the feature vectors are loaded only once. As a result, the communication traffic and the CPU load can be suppressed.

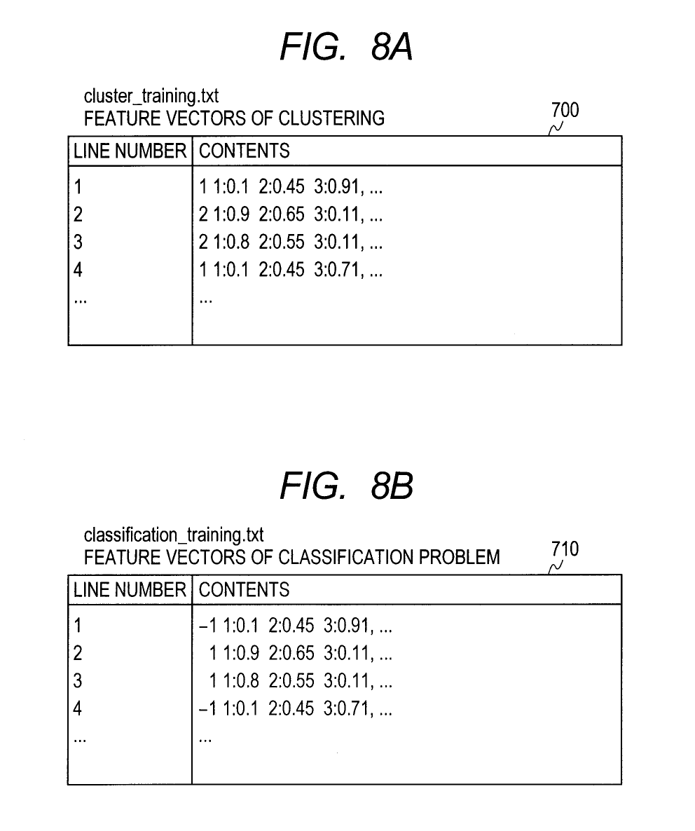

FIGS. 8A and 8B illustrate an example of the feature vectors used for the machine learning according to the present invention. Data obtained by converting data of various formats such as documents of a natural language or image data so as to be easy to deal with is the feature vectors.

FIG. 8A illustrates feature vectors 700 of clustering, and FIG. 8B illustrates feature vectors 710 of a classification problem, which are the feature vectors stored in the master data storage 280 of FIG. 2. Each of the feature vectors 700 and 710 includes a set of label and numerical vector. One label and one numerical vector are described on each line. A first column indicates the label, and second and subsequent columns indicate the numerical vectors. For example, on a first line of data in FIG. 8A, the label is “1”, the numerical vector is “1:0.1 2:0.45 3:0.91, . . . ”. The numerical vectors are described in a format of “No. of a dimension: value”. In an example of the first line of data in FIG. 8A, a first dimension of the vector is 0.1, a second dimension is 0.45, and a third dimension is 0.91. The necessary item of the feature vectors 700 is the numerical vector, and the label may be omitted as the occasion demands. For example, the label is allocated to the feature vectors 700 used during learning, but no label is allocated to the feature vectors 700 used for test. Also, in the case of unsupervised learning, no label is allocated to the feature vectors used for learning.

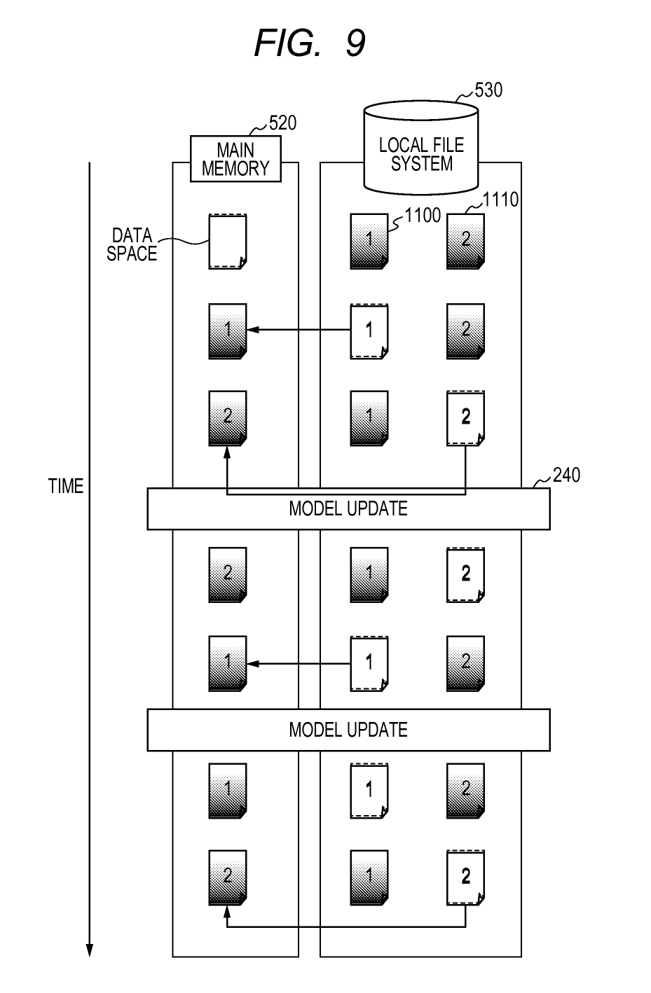

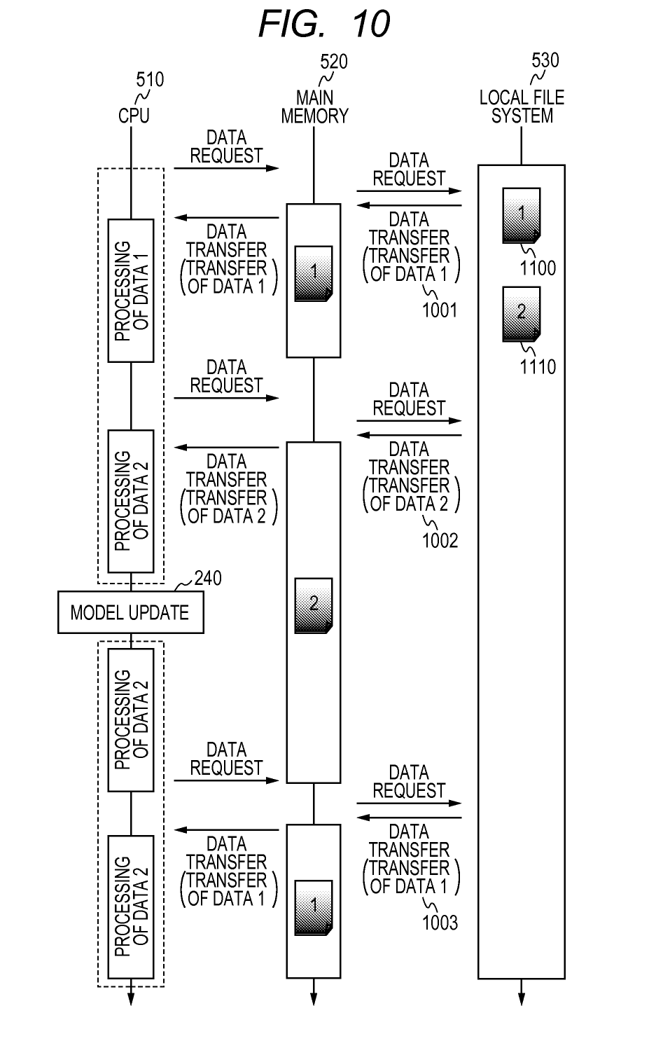

In the machine learning, the order of the read feature vectors does not influence the results. With the use of the features of the machine learning, the order of loading the feature vectors from the local file systems 530 into the data area of the main memory 520 is optimized as illustrated in FIGS. 9 and 10. As a result, the order is changed for each iteration process illustrated in FIG. 4 whereby a load time of the feature vectors can be reduced.

FIG. 9 is a schematic diagram illustrating an example in which the data processor 210 loads data from the feature vectors storage 220 of the local file system 530 into a given data area of the main memory 520. FIG. 10 is a sequence diagram illustrating an example in which the data processor 210 loads the feature vectors of the local file system 530 into the data area of the main memory 520.

Now, let us consider a case in which the amount of data of the feature vectors stored in the input data 200 of the local file systems 530 is twice as large as a size of the data area set in the main memory 520. In this case, the feature vectors are divided into multiple segments each of which is called “data segment 1 (1100)”, and “data segment 2 (1110)”. The size of the data area on the main memory 520 is ensured in advance with a given capacity that enables those data segments 1 and 2 to be stored.

Hereinafter, a data load of the iteration process will be described with reference to FIG. 10. In a first data load (1001), the CPU 510 first loads the data segment 1 (1100) from the local file systems 530 into the data area of the main memory 520, and releases the data segment 1 as soon as the processing (processing of data 1) is completed. Then, the CPU 510 loads the data segment 2 (1110) from the local file systems 530 into the data area of the main memory 520. Even if the processing (processing of data 2) is completed, the CPU 510 retains the data segment 2 on the data area of the main memory 520. After the model update (240) is conducted, in a second iteration process, the processing (processing of data 2) starts from the data segment 2 retained on the data area of the main memory 520. Likewise, in a 2*i^{th}{i|iεZ} iteration, the processing is conducted from the data segment 1, and in a 2*i+1^{th} iteration, the processing is conducted from the data segment 2. With this operation, the number of loading the feature vectors from the local file systems 530 is half as compared with a case in which the feature vectors are load from the data segment 1 each time, and the machine learning can be executed at a high rate.

### <Interrupt of Execution>

In the present invention, the processing can be interrupted during the machine learning.

Upon receiving an instruction to interrupt the processing from the controller of distributed computing 260, the respective data processors 210 completes the learning process during execution, and sends the calculation results to the model updater 240. Thereafter, the data processors 210 temporarily stop executing a subsequent learning process. Then, the data processors 210 release the feature vectors loaded on the main memory 520.

Upon receiving an instruction to interrupt the processing from the controller of distributed computing 260, the model updater 240 waits for a partial result from the data processors 210, and continues the processing until the integrated process during execution is completed. Thereafter, the model updater 240 withholds the convergence check, and waits for an instruction of the interrupt cancel (learning restart) from the controller of distributed computing 260.

### <Restart of Learning Process>

Upon receiving the instruction of the learning restart from the master node 600, the respective worker nodes 1 to 3 load the feature vectors from the feature vector storages 220 in the local file systems 530 into the main memory 520. The respective worker nodes 1 to 3 execute the iteration process with the use of the learning parameter transferred from the master node 600. Subsequently, the processing returns to the same procedure as that during normal execution.

As described above, according to the present invention, in the distributed computer system that conducts the learning process in parallel, the controller of distributed computing 260 of the master node 600 (second computer) assigns the feature vectors, and assigns the data processors 210 and the model updater 240 to the worker nodes 1 to 4 (first computers). The data processors 210 of the worker nodes 1 to 3 have charge of the iteration calculation of the machine learning algorithms, acquires the feature vectors from the distributed file system 620 (storage) over the network at the time of starting the learning process, and stores the acquired feature vectors in the local file systems 530 (local storage). The data processors 210 loads the feature vectors from the local file systems 530 at the time of iterating the second and subsequent learning processes, and conducts the learning process. The feature vectors are retained in the local file systems 530 or the main memory 520 until completion of the learning process. The data processors 210 sends only the results of the learning process to the model updater 240, and waits for a subsequent input (learning model) from the model updater 240. The model updater 240 initializes the learning model and the parameters, integrates the results of the learning process from the data processors 210, and checks the convergence. If the learning model is converged, the model updater 240 completes the processing, and if the learning model is not converged, the model updater 240 sends the new learning model and the model parameters to the data processors 210, and iterates the learning process. In this situation, since the data processors 210 reuses the feature vectors of the local file systems 530 without accessing to the distributed file system 620 over the network, the data processors 210 suppresses the start and end of the learning process and the load of data from the distributed file system 620, thereby enabling the processing speed of the machine learning to be improved.

An execution time of the k-means method for parallelization according to the present invention is measured. In the experiment, there are used one master node 600, six worker nodes 610, one distributed file system 620, and the LAN 630 of 1 Gbs. As the feature vectors 310, 50-dimensional numerical vectors belonging to four clusters are used. The experiment is conducted while the number of records of the feature vectors is changed to 200,000 pieces, 2,000,000 pieces, and 20,000,000 pieces.

The master node has eight CPUs 510, the main memory 520 of 3 GB, and the local file system of 240 GB. Four of six worker nodes have eight CPUs, and the main memory 520 of 4 GB, and the local file system of 1 TB. The rest of worker nodes have four CPUs, and the main memory 520 of 2 GB, and the local file system of 240 GB. The eight data processors 210 are executed in the four worker nodes having the main memory of 4 GB, and the four data processors are executed in the two worker nodes having the main memory of 2 GB. The one model updater 240 is executed in one of the six worker nodes.

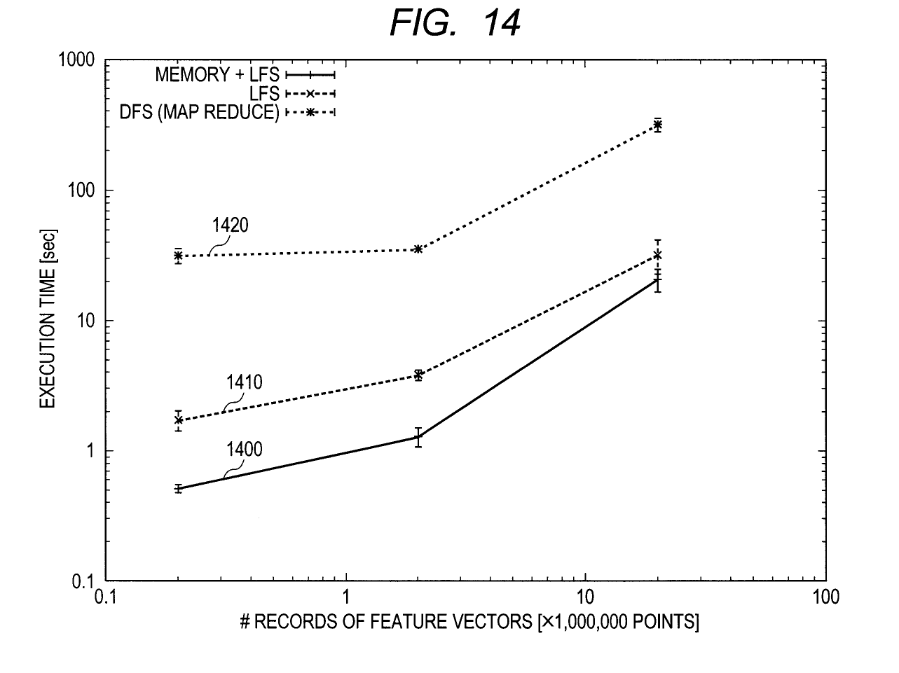

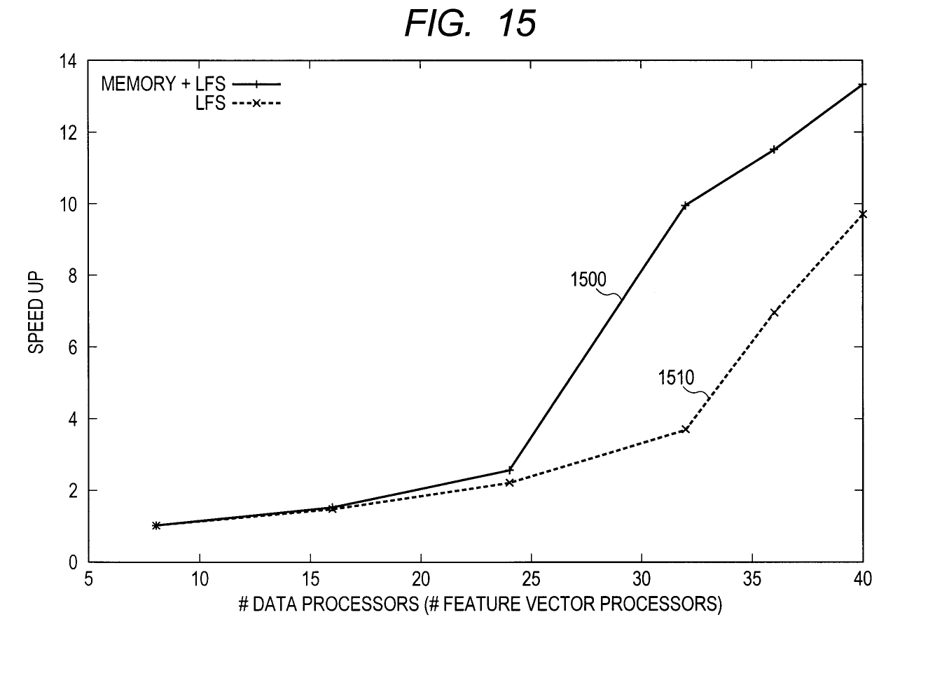

FIG. 14 represents an execution time per one iteration process with respect to the size of each data. The axis of abscissa is a size of data, and the axis of ordinate is the execution time (sec.). FIG. 14 represents a double logarithmic chart. A Memory+LFS showing the results by a polygonal line 1400 represents a case in which the feature vectors are stored in the local file systems 530 of the worker nodes 610, and the feature vectors in the main memory 520 is used. The feature vectors of 200,000 pieces are cached in the main memories of the respective worker nodes, and reused in the iteration calculation. An LFS showing the results by a polygonal line 1410 represents a case in which the feature vectors are stored in the local file systems 530 of the worker nodes 610, and the feature vectors in the main memory 520 is not used. A DFS (MapReduce) showing the results by a polygonal line 1420 represents a case in which the K-means method is implemented with the use of the MapReduce, and the feature vectors of the network 630 are used. In all of the data, the Memory+LFS completes the processing earlier than that of the LFS, and the LFS completes the processing earlier than that of the MapReduce. When data of 200,000 pieces is used, the Memory+LFS executes the processing faster than the DFS (MapReduce) by 61.3 times. When data of 2,000,000 pieces is used, the Memory+LFS executes the processing faster than the DFS (MapReduce) by 27.7 times. When data of 20,000,000 pieces is used, the Memory+LFS executes the processing faster than the DFS (MapReduce) by 15.2 times. The Memory+LFS shows a large improvement in the speed, that is, 3.33 times and 2.96 times as compared with the LFS in the case of the feature vectors of 200,000 pieces and 2,000,000 pieces where all of the feature vectors are cached in the main memory. The execution time in the k-means method in which parallelization is conducted according to the present invention is measured while incrementing the number of worker nodes from one to six one by one. In the order of adding the worker nodes, the first to fourth worker nodes each have eight data processors 210, and the fifth and sixth worker nodes each have four data processors. As the feature vectors 310, 20,000,000 pieces of 50-dimensional numerical vectors belonging to the four clusters are used. In this experiment, one model updater 240 is assigned to one of six worker nodes. FIG. 15 illustrates a speed up to the number of data processors. The criterion of speed-up is based on a case where eight CPUs are provided. The result of the Memory+LFS is indicated by a polygonal line 1500, and the result of the LFS is indicated by a polygonal line 1510. In both of the Meomory+LFS and LFS, the number of worker nodes is increased to increase the speed-up. When 16 CPUs in total are used in two worker nodes, the speed is improved 1.53 times. When 40 CPUs in total are used in the six worker nodes, the speed is improved 13.3 times. In the LFS, when 16 CPUs in total are used in the two worker nodes, the speed is improved 1.48 times. When 40 CPUs in total are used in the six worker nodes, the speed is improved 9.72 times. In the Memory+LFS and the LFS, the number of worker nodes as well as the number of CPUs and LFSs is increased to distribute the processing, thereby improving the speed. In addition, in the case of the Memory+LFS, the amount of the feature vectors that are cached in the main memory is also improved, and the speed-up is increased more than that in the case of the LFS.

### Second Embodiment

Subsequently, a second embodiment of the present invention will be described. A configuration of a distributed computer system used in the second embodiment is identical with that in the first embodiment.

The transmission of the learning results in the data processors 210 to the model updater 240, and the integration of the learning results in the model updater 240 are different from those in the first embodiment. In the second embodiment, only the feature vectors on the main memory 520 is used for the learning process during the learning process in the data processors 210. When the learning process of the feature vectors on the main memory 520 is completed, the partial results are sent to the model updater 240. In this sending, the data processors 210 load the unprocessed feature vectors in the feature vector storages 220 of the local file systems 530 into the main memory 520, and replace the feature vectors.

Through the above processing, a wait time for communication in the model updater 240 can be reduced. Hereinafter, a description will be given of only differences between the first embodiment and the second embodiment.

It is assumed that there exist the feature vectors twice as large as the amount of memory that can be dealt with by the data processors 210. It is assumed that the data processors 210 sets an area where the feature vectors are stored on the main memory 520, and an area where the learning results are stored. For convenience, it is assumed that the feature vector storages 220 on the local file systems 530 is divided into two pieces of the data segment 1 (1100) and the data segment 2 (1110) as illustrated in FIG. 9.

First, the data processors 210 learn the data segment 1. Upon completion of the learning process, the communication thread (not shown) and the feature vectors load thread (not shown) are activated (executed). While the data load thread loads the data segment 2, the communication thread sends intermediate results to the model updater 240. Upon receiving the intermediate results from the respective data processors, the data updater updates a new model parameter as needed. The learning process in the data processor is executed without waiting for the completion of the communication thread when the feature vectors are loaded. In this way, the model updater 240 grasps the intermediate results of the data processors 210 whereby the model updater 240 can conduct the calculation (integrated processing) with the use of the intermediate results even while the data processors 210 is conducting the learning process. For that reason, a time required for the integrated processing to be executed at the time of completing the learning of the data processors 210 can be reduced. As a result, the machine learning process can be further increased in the processing speed.

### Third Embodiment

Subsequently, a third embodiment of the present invention will be described. An ensemble learning is known as one machine learning technique. The ensemble learning is a learning technique of creating multiple independent models and integrating the models together. When the ensemble learning is used, even if the learning algorithms are not parallelized, the construction of the independent learning models can be conducted in parallel. It is assumed that the respective ensemble techniques are implemented on the present invention. The configuration of the distributed computer system according to the third embodiment is identical with that of the first embodiment. In conducting the ensemble learning, the learning data is fixed to the data processors 210, and only the models are moved whereby the communication traffic of the feature vectors can be reduced. Hereinafter, only differences between the first embodiment and the third embodiment will be described.

It is assumed that m data processors 210 are used for the ensemble learning. There are 10 kinds of the machine learning algorithms that operate by only a single data processor 210. When the controller of distributed computing 260 sends the data processors 210 to the worker nodes 1 to m, all of the machine learning algorithms are sent. In a first processing of the data processor 210, the feature vectors are loaded into the respective local file systems 530 from the master data storage 280 in the distributed file system 620.

Then, in the respective data processors 210, the learning of a first kind of algorithm is conducted, and the results are sent to the model updater 240 after learning. In second and subsequent processing, algorithms not learned are sequentially learned. In this situation, the algorithms and the feature vectors existing on the main memory 520 or the local file systems 530 are used. The processing of the data processors 210 and the model updater 240 is iterated 10 times in total whereby all of the algorithms are learned for all of the feature vectors.

Through the above method, the ensemble learning can be efficiently conducted without moving the feature vectors large in data size from the data processors 210 of the worker nodes.

The present invention made by the present inventors have been described in detail with reference the embodiments. However, the present invention is not limited to the above embodiments, but can be variously changed without deviating from the subject matter of the invention.

In the respective embodiments, an example in which the feature vectors 310 are stored in the master data storage 280 of the distributed file system 620 is described. The storage accessible from the worker nodes 610 can be used, and are not limited to the distributed file system 620.

Also, in the above respective embodiments, an example in which the controller of distributed computing 260, the data processors 210, and the model updater 240 are executed by the independent computer 500 is described. Alternatively, the respective processors 210, 240, and 260 may be executed on a virtual computer.

As has been described above, the present invention can be applied to the distributed computer system that executes the machine learning in parallel, and more particularly can be applied to the distributed computer system that executes the data processing including the iteration process.

What is claimed is:

1. A distributed computing system comprising:
a first computer including a processor, a main memory, and a local storage;
a second computer including a processor and a main memory, and instructing a distributed process to a plurality of the first computers;
a storage that stores data used for the distributed process; and
a network that connects the first computers, the second computer, and the storage, for conducting the parallel process by the first computers,
wherein the second computer includes a controller that allows the first computers to execute a learning process as the distributed process,
wherein the controller causes a given number of first computers among the first computers to execute the learning process as first worker nodes by assigning data processors that execute the learning process and the data in the storage to be learned for each of the data processors to the given number of first computers,
wherein the controller causes at least one first computer among the first computers to execute the learning process as a second worker node by assigning a model updater that receives outputs of the data processors and updates a learning model to the one first computer,
wherein in the first worker nodes, each data processor loads the data assigned from the second computer from the storage, and stores the data into the local storage, sequentially loads the unprocessed data among the data in the local storage in an area secured in advance on the main memory, executes the learning process on the data in the data in the data area, and sends a results of the learning process to the second worker node, and
wherein in the second worker node, the model updater receives the results of the learning process from the first worker nodes, updates the learning model from the results of the learning process, determining whether the updated learning model satisfies given criteria, or not, sends the updated learning model to the first worker nodes to instruct the first worker nodes to conduct the learning process if the updated learning model does not satisfy the given criteria, and sends the updated learning model to the second worker node to instruct the first worker nodes to conduct the learning process if the updated learning model satisfies the given criteria.

2. The distributed computing system according to claim 1,
wherein the data processor loads the data stored in the local storage in a given order when loading the data from the local storage in the main memory.

3. The distributed computing system according to claim 2,
wherein, the data processor receives the learning model from the second worker node and again conducts the learning process after completing the learning process and sending the results of the learning process to the second worker node, the data processor starts the learning process from the data retained on the data area of the main memory.

4. The distributed computing system according to claim 1,
wherein the data processor sends the results of the completed learning process to the second worker node as the results of a partial learning process when the data processor loads the unprocessed data from the local storage in the memory after loading the data from the local storage in the data area of the main memory, and completes the learning process on the data in the data area.

5. The distributed computing system according to claim 1,
wherein the second computer includes a plurality of learning models in advance, sends one of the learning models to each data processor of the first computers that function as the first worker nodes, and sends the learning models to the model updater of the first computer that functions as the second worker node, and
wherein in the second worker node, upon receiving the results of the learning process from the first worker nodes, the model updater sends another other learning model to the first worker nodes, and instructs the first worker nodes to start the learning process.
